(19) United States
(12) Patent Application Publication
(10) Pub. No.: US 2010/0020039 A1
(43) Pub. Date: Jan. 28, 2010

(54) TOUCH INPUT DEVICE WITH DISPLAY FRONT

(75) Inventors: Theodore K. Ricks, Rochester, NY (US); Mitchell S. Burberry, Webster, NY (US); David M. Johnson, West Henrietta, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INDUSTRIAL TECHNOLOGY RESEARCH INSTITUTE

(21) Appl. No.: 12/550,311

(22) Filed: Aug. 28, 2009

Related U.S. Application Data
(63) Continuation of application No. 11/252,046, filed on Oct. 17, 2005.

(51) Int. Cl. G06F 3/041

(52) U.S. Cl. 345/173

(57) ABSTRACT

An electrically updatable device having a touch sensor and a flexible display is disclosed, wherein the display is between the touch sensor and a viewer. The display comprises a pressure-insensitive imaging layer of polymer-dispersed imaging material, wherein the thickness of the imaging layer is defined by the polymer.

### RELATED APPLICATION

This application is a continuation application of and hereby claims the priority benefit to U.S. patent application Ser. No. 11/252,046 filed Oct. 17, 2005, incorporated herein by reference in its entirety.

### FIELD OF THE INVENTION

The present invention relates to a touch sensitive device with an electronically addressable display front and systems including such devices.

### BACKGROUND OF THE INVENTION

Since their conception in the 1970's, touchscreen displays have grown into one of the most popular forms of user interface in the computing world. Kiosks, machine controllers, and personal digital assistants (PDAs), are just a few of the common devices that utilize this technology. Touchscreen simplicity combined with display adaptability can be made to serve the function of a keyboard, mouse, pen, number pad, and many other input devices, all combined into a single unit. Touchscreen display assemblies are typically formed by positioning a touch-sensing layer or field in front of the display relative to the user. Today there are four popular ways to make a display touch sensitive: Resistive, Capacitive, Ultrasonic, and Infrared.

The resistive style consists of two clear conductors spaced apart by physical dots. When the assembly is depressed, the conductors touch and detectors determine the touch location by measuring the currents in the x and y directions. This method is the least expensive and does not require a conductive stylus, but it suffers up to 25% of optical loss. Resistive touchscreens are typically manufactured independently of the final device for which they are used, as this is frequently the most cost effective manner for production. One way that this is accomplished is to coat two rolls or sheets of substrate material with a clear conductor, for example a sputter coated layer of Indium Tin Oxide (ITO), then screen print spacers and sensing electronics, and laminate the two substrates. In this manner, touchscreens can be made in an inexpensive, high-volume manner, then applied to any number of devices.

A second touchscreen style utilizes capacitance to identify touch location. The capacitive style requires only one conductive layer, which is typically arranged as the outermost layer of the device. Like in the resistive system, capacitive touchscreens can also be manufactured off-line, to be integrated later into the device. Capacitive touchscreens are advantageous because there is only one substrate, no spacers are required, and the optical transmissivity can be as much as 90%. Capacitive sensors are limited in that they require a conductive stylus, and the exposed conductive layer can be damaged during use. Protective outer coating materials do exist, but are very limited.

The final two popular methods for making a touchscreen, ultrasonic and infrared (IR) sensing, are very similar. Both styles use signal generators and receivers placed around the perimeter of the display. In the ultrasonic format, sonic waves are generated. In the IR format, infrared light beams are generated. In both, an array of beams or waves cover the surface of the display, and the sensors identify a touch location based on which beams are broken or what waves are bounced back. These systems cannot be integral to the display, and tend to be separate components of a larger assembly. Their major advantage is that they do not require a conductive stylus and have no optical loss. However, given the large number of generators and sensors required, they are the most expensive of the options, and can be very sensitive to surface flatness. These issues make such touchscreens infeasible for use with inexpensive, flexible displays.

Regardless of the style of sensing method used, touchscreen display assemblies can have significant problems. The first problem is that many types of displays are significantly pressure sensitive. If a surface of the display is deflected, it can cause a temporary optical imperfection, as is the case for typical liquid crystal displays (LCD), or permanent display failure, as is the case for many electrophoretic materials. In the LCD example, the optical characteristics and drive voltage of the display material is dependant on the thickness and planarity of the layer. If the display is deformed, then the thickness can change, causing an optical defect. In electrophoretic systems, the damage can be permanent. For example, pressure on the display layer can lead to seizure of rotating elements due to matrix distortion, or rupture of electrophoretic cell seals due to delamination.

The second problem with traditional touchscreen-in-front assemblies is the significant potential optical losses in the display due to the presence of the touch-sensing layer. This is not an issue for IR or ultrasonic styles of touchscreens, but it can be a significant issue when resistive or capacitive styles are utilized. This is unfortunate, as they are much preferred from a system cost perspective. Placing a touchscreen in front of a display can lead to 10% to 25% of loss in brightness and contrast, due to the maximum transmissivity of the screens.

In U.S. Pat. No. 4,789,858, Fergason and McLaughlin addressed the pressure sensitivity issue by encapsulating an LC material into a large number of discrete capsules. This structure held the LC material in its original thickness, regardless of layer deflection due to touch inputs. With this structure, the user could put significant pressure on the display layer, and even if the entire layer shifted, the capsules would keep the LC from migrating out, limiting optical defects. Although Fergason and McLaughlin addressed the first problem plaguing traditional touchscreen displays, they stayed with the touchscreen-in-front arrangement, and therefore did not address the second.

Others have tried to address the optical loss issue by rearranging the typical position of the touchscreen and display, relative to the user. Typically, flexible touchscreens are placed in front of a rigid display. This allows the touchscreen to flex, sensing the input, while the display remains mostly unaffected. However, if the display can be made to flex, then the order of assembly can be reversed. This places the touchscreen behind the display, eliminating the optical loss between the viewer and the image. However, this rearrangement of the structure places even more importance on the pressure sensitivity of the display. Where before the displays had the potential to see some deformation due to pressure, with this reversed structure, deformation of the display is actually required.

In U.S. Pat. No. 5,907,375, Nishikawa et. al. attempted to address the pressure sensitivity of LC displays in a touchscreen-in-back assembly by adding at least a shock-absorbing layer, and sometimes also a reinforcing plate, to the display assembly. These layers dissipated any touch input, in an effort to reduce the angle of distortion applied to the LC layer. This approach may be effective in reducing damage to the LC layer, but it does add at least one additional layer to the system, and reduces the sensitivity and resolution of pressure inputs.

Atkins et. al. attempted a different approach in U.S. Pat. No. 5,623,280 by including a ribbed substrate, designed to maintain LC layer thickness. It may accomplish that, but the system still has the significant risk of delamination, and adds the difficulty and expense of creating and assembling a physically patterned substrate. In addition, it requires at least three substrates, limiting the versatility of the assembly and reducing the capability of future system reduction.

WO 2005/078566 describes a touch screen display assembly having a touch sensitive portion and a display portion, but does not address the inherent pressure sensitivity of existing display technologies.

There is a need for a touch sensitive display system that takes advantage of the optical advantages of a touchscreen-in-back structure, without the image quality or touch sensitivity degradation due to pressure sensitivity.

### SUMMARY OF THE INVENTION

An electrically updatable device is described, wherein the device includes a touch sensor and a flexible display, wherein the display is between the touch sensor and a viewer, and wherein the display comprises a pressure-insensitive imaging layer of polymer-dispersed imaging material, wherein the thickness of the imaging layer is defined by the polymer.

### ADVANTAGES

The touch sensitive device can be made at a reduced cost with improved optical properties of the display. The system can use minimal power. The system can be lightweight, portable, flexible, or a combination thereof.

### BRIEF DESCRIPTION OF THE DRAWINGS

The invention as described herein can be understood with reference to the accompanying drawings as described below:

FIG. 1 is a side view of a traditional resistive touchscreen and display assembly;

FIG. 2 is a side view of a traditional resistive touchscreen and display assembly with the touchscreen actuated;

FIG. 3 is a cross-section view of a polymer-dispersed, display assembly;

FIG. 4 is a cross-section view of a polymer-dispersed, display assembly in a flexed position;

FIG. 5 is a side view of a touchscreen display wherein a transparent touchscreen is positioned behind a flexible display;

FIG. 6 is a side view of a touchscreen display wherein an opaque touchscreen is positioned behind a flexible display;

FIG. 7 is a side view of a touchscreen display wherein the display is constructed as an integral part of the touchscreen assembly;

FIG. 8 is a side view of a touchscreen display wherein the display is constructed as an integral part of the touchscreen assembly, and the writing of the display and positional sensing of the touchscreen can be done simultaneously;

FIG. 9 is a side view of a modification to the system of FIG. 8 with the addition of a third display electrode;

FIG. 10 is a front view the system of FIG. 8 or 9 with some pixels written to a different optical state;

FIG. 11 is a side view of the system of FIG. 9 with the all pixels written to the same optical state;

FIG. 12 is a front view the system of FIG. 8, 9, or 11 with all pixels written to the same optical state;

FIG. 13 is a front view of a traditional spacer design;

FIG. 14 is a front view of an alternative spacer design; and

FIG. 15 is an isometric view of flexible touchscreen display assembly.

The drawings are exemplary only, and depict various embodiments of the invention. Other embodiments will be apparent to those skilled in the art upon review of the accompanying text.

### DETAILED DESCRIPTION OF THE INVENTION

A touch-sensitive assembly and an electronic, rewritable display can be combined to form a touch-input device with updateable display capability. Such a device can be used in multiple applications including, but not limited to, kiosks for picture-making, airline reservations, or information; industrial controllers; data input devices such as automated teller machines, or ordering systems such as used in restaurants; notation board; informational signage; or various interactive consumer products, such as video games, toys, watches, calculators, PDAs, and electronic books.

The device can include a touch input sensor. The sensor can be a mechanical actuator, an electrical sensor, or an electromechanical device. The sensor can be a resistive touchscreen, wherein two electrodes are held apart by a gap, and positional sensing occurs when the electrodes are brought into contact. The touchscreen can be a capacitive touchscreen, wherein positional sensing occurs when a conductive material with some finite capacitance contacts a conductive layer. The touchscreen can be partially or completely flexible.

The device can include one or more sheets of display media, hereafter referred to as “media,” capable of displaying an electronically updateable image. The media can have a first and second conductor. The first and second conductor can be patterned. The first conductor pattern can be defined as the “columns” of the display and the second conductor can be defined as the “rows” of the display. The rows and columns can interact to form a passive matrix, with a “pixel” being defined as each area where a row and column overlap. The media can be designed such that the electrical connections for the rows are made along one edge of the sheet, and the connections for the columns are made along a different edge. The media can be designed such that the display area defined by the rows and columns is larger in any direction than the area required for electrical interconnects. The media can be designed such that the row and column electrical connections are all routed to one edge. The media can be assembled with electronic drivers to form a display. The display can be constructed such that it can be rolled or folded to reduce the assembly size for transportation or storage. Two or more media can be joined together to form a display.

The display media can be a polymer dispersed imaging material, for example, liquid crystal or electrophoretic materials. The display media can contain an electrically imageable material which can be addressed with an electric field and then retain its image after the electric field is removed, a property typically referred to as “bistable.” Particularly suitable electrically imageable materials that exhibit “bistability” are chiral nematic, or cholesteric, liquid crystals.

According to one embodiment, cholesteric liquid crystal can be used as the imaging material. Cholesteric liquid crystal refers to the type of liquid crystal having finer pitch than that of twisted nematic and super-twisted nematic used in commonly encountered LC devices. Cholesteric liquid crystals are so named because such liquid crystal formulations are commonly obtained by adding chiral agents to host nematic liquid crystals. Cholesteric liquid crystals may be used to produce bistable or multi-stable displays. These devices have significantly reduced power consumption due to their nonvolatile “memory” characteristic. Because such displays do not require a continuous driving circuit to maintain an image, they consume significantly reduced power. Cholesteric displays are bistable in the absence of an electric field. The two stable textures are the reflective planar texture and the weakly scattering focal conic texture. Adjusting the concentration of chiral dopants in the cholesteric material modulates the pitch length of the mesophase and, thus, the wavelength of radiation reflected. Cholesteric materials that reflect infrared radiation and ultraviolet have been used for purposes of scientific study. Commercial displays are most often fabricated from cholesteric materials that reflect visible light.

A problem with typical memory type cholesteric liquid crystal displays is that they are pressure sensitive. If the display media is flexed, thereby applying pressure to the liquid crystals in the display, the display can change state, thereby obscuring the data written on the display. This is particularly a problem for use in front of a touch screen where the display will be repeatedly flexed. Other bistable display media have additional pressure sensitivity problems. Most electrophoretic materials are destroyed with applied pressure. Therefore, the display media needs to be pressure insensitive.

U.S. Pat. No. 6,853,412 discloses a pressure insensitive display media containing a polymer dispersed cholesteric liquid crystal layer. The polymer dispersed cholesteric liquid crystal layer includes a polymeric dispersed cholesteric liquid crystal (PDLC) material, such as the gelatin dispersed cholesteric liquid crystal material. One preferred method of making such emulsions, using limited coalescence, is disclosed in EP 1 115 026A. Liquid crystal materials disclosed in U.S. Pat. No. 5,695,682 may be suitable if the ratio of polymer to liquid crystal is chosen to render the composition insensitive to pressure. Application of electrical fields of various intensity and duration can drive a cholesteric material into a reflective state, to a transmissive state, or an intermediate state. These materials have the advantage of maintaining a given state indefinitely after the field is removed. Cholesteric liquid crystal materials can be MERCK BL112, BL118, or BL126, available from E.M. Industries of Hawthorne, N.Y.

A cholesteric liquid crystal composition can be dispersed in a continuous matrix. Such materials are referred to as “polymer dispersed liquid crystal” materials or “PDLC” materials. Such materials can be made by a variety of methods. For example, Doane et al. (Applied Physics Letters, 48, 269 (1986)) disclose a PDLC comprising approximately 0.4 .mu.m droplets of nematic liquid crystal 5CB in a polymer binder. A phase separation method is used for preparing the PDLC. A solution containing monomer and liquid crystal is filled in a display cell and the material is then polymerized. Upon polymerization, the liquid crystal becomes immiscible and nucleates to form droplets. West et al. (Applied Physics Letters 63, 1471 (1993)) disclose a PDLC comprising a cholesteric mixture in a polymer binder. Once again, a phase separation method is used for preparing the PDLC. The liquid crystal material and polymer (a hydroxy functionalized polymethylmethacrylate) along with a crosslinker for the polymer are dissolved in a common organic solvent toluene and coated on an indium tin oxide (ITO) substrate. A dispersion of the liquid crystal material in the polymer binder is formed upon evaporation of toluene at high temperature. The phase separation methods of Doane et al. and West et al. require the use of organic solvents that may be objectionable in certain manufacturing environments. These methods can be applied to other imaging materials, such as electrophoretic materials, to form polymer dispersions of the imaging materials.

Each discrete polymer-dispersed portion of imaging material is referred to as a “domain.” The contrast of the display is degraded if there is more than a substantial monolayer of domains. The term “substantial monolayer” is defined by the Applicants to mean that, in a direction perpendicular to the plane of the display, there is no more than a single layer of domains between the electrodes at most points of the imaging layer, preferably at 75 percent or more of the points, most preferably at 90 percent or more of the points of the imaging layer. In other words, at most, only a minor portion (preferably less than 10 percent) of the points of the imaging layer in the display has more than a single domain (two or more domains) between the electrodes in a direction perpendicular to the plane of the display, compared to the amount of points (or area) in the imaging layer at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

One example of a display media sheet has simply a single imaging layer of polymer dispersed liquid crystal material along a line perpendicular to the face of the display, preferably a single layer coated on a flexible substrate. Such a structure, as compared to vertically stacked imaging layers, is especially advantageous for monochrome displays. Structures having stacked imaging layers can be used to provide additional advantages in some cases, such as color.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains can be defined as having a major axis and a minor axis. In a preferred embodiment of a display or display sheet, the major axis is larger in size than the imaging material layer thickness for a majority of the domains. Such a dimensional relationship is shown in U.S. Pat. No. 6,061,107. The domains are encapsulated with sufficient polymer so the domains can maintain an optical state when pressure or bending forces are applied to the imaging layer in an area of the display.

The flexible substrate can be any flexible self-supporting material that supports the conductor. Typical substrates can include plastics, glass, or quartz. “Plastic” means a polymer, usually made from polymeric synthetic resins, which may be combined with other ingredients, such as curatives, fillers, reinforcing agents, colorants, and plasticizers. Plastic includes thermoplastic materials and thermosetting materials.

The flexible material must have sufficient thickness and mechanical integrity so as to be self-supporting, yet should not be so thick as to be rigid. Typically, the flexible substrate is the thickest layer of the display. Consequently, the substrate determines to a large extent the mechanical and thermal stability of the fully structured display.

The flexible substrate can be polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alkoxy) fluoropolymer (PFA), poly(ether ether ketone) (PEEK), poly(ether ketone) (PEK), poly(ethylene tetrafluoroethylene)fluoropolymer (PETFE), poly(methyl methacrylate), various acrylate/methacrylate copolymers (PMMA), or a combination thereof. Aliphatic polyolefins may include high density polyethylene (HDPE), low density polyethylene (LDPE), and polypropylene, including oriented polypropylene (OPP). Cyclic polyolefins may include poly(bis(cyclopentadiene)).

A preferred flexible plastic substrate is a cyclic polyolefin or a polyester. Various cyclic polyolefins are suitable for the flexible plastic substrate. Examples include Arton.™. made by Japan Synthetic Rubber Co., Tokyo, Japan; Zeanor T.™. made by Zeon Chemicals L.P., Tokyo Japan; and Topas.™. made by Celanese A. G., Kronberg Germany. Arton.™. is a poly(bis(cyclopentadiene)) condensate that is a film of a polymer. Alternatively, the flexible plastic substrate can be a polyester. A preferred polyester is an aromatic polyester such as AryLite.™. (Ferrania). Although various examples of plastic substrates are set forth above, it should be appreciated that the substrate can also be formed from other materials such as glass and quartz.

Although the discussion above is centered around using a polymer dispersed liquid crystal layer on a flexible polymer support, it will be understood by those practiced in the art that the display media can be any flexible, pressure insensitive, electronically updateable media. Other suitable materials can include, for example, electrochemical materials, electrophoretic materials, electrowetting materials, magnetic materials, electrochromic materials, or other liquid crystal materials.

The display as described herein can include a pre-written image in the display material, such as text, numbers, or symbols, that is changeable or unchangeable. The display can be permanently pre-written with applied text, numbers, or symbols, such as by ink jet, gravure, or thermal printing on the substrate, one or more conductive layer, or the imaging material layer of the display, or by application of a permanent or removable label.

The touch-input device can combine the display media and a touch sensor to form a touch sensor with visually updateable properties, or a display with touch input capability. The device can be assembled such that the media is placed between the user and the touch sensor. The media and the touchscreen can be separate, temporarily attached, permanently attached, or integrated into a single unit. The touchscreen and media can be transparent, translucent, opaque, or a combination thereof. The touchscreen and media can be the same size or shape, or different sizes or shapes. The media and touchscreen can each be completely or partially flexible. The media and touchscreen can each independently be permanently or temporarily attached to drive electronics. The drive electronics for the media and touchscreen can be separate or integrated.

The device can be understood with reference to certain embodiments including a cholesteric liquid crystal display element, as depicted in the Figures and described below.

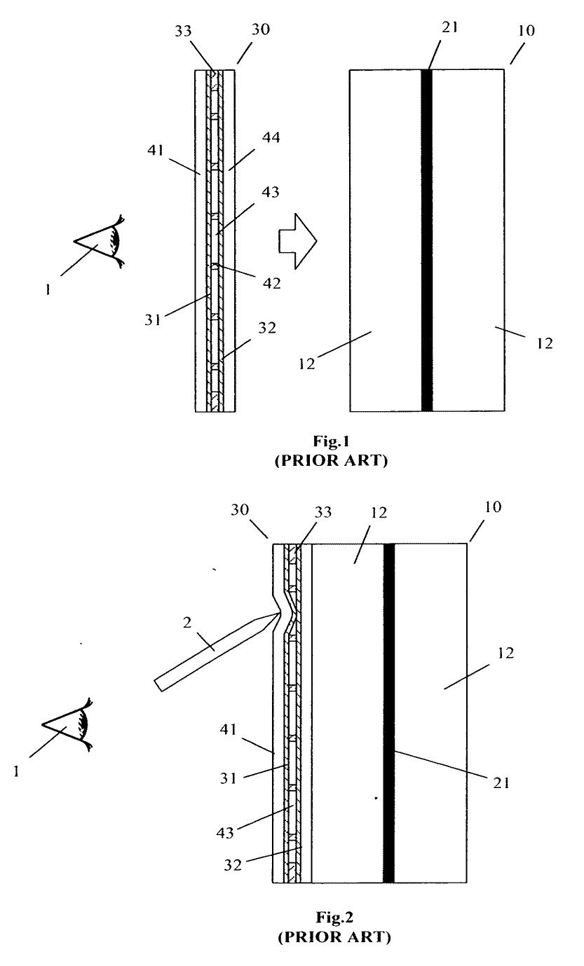

FIG. 1 shows a side view of a traditional touchscreen-display device as known in the art. In this embodiment, the device consists of a resistive touchscreen 30 applied to the viewer 1 side of a rigid display plane 10. The display plane consists of a first glass substrate 12, an active display layer 21, and a second glass substrate 12. The glass substrates are held at a specific distance from one another in any of a variety of ways, including, but not limited to, spacer beads, embedded fibers, polymer layers, or microfeatures. The resultant display is typically very rigid, but sensitive to pressure, as many of the spacing methods compress under a load. Reduction of the gap between substrates can lead to appearance or electrical behavior changes in the display. In the case when a touchscreen is to be added to the system, it is typically made as a separate assembly and attached to the display plane in subsequent steps. A resistive touchscreen 30 typically consists of a flexible, transparent, first touchscreen substrate 41, a transparent first touchscreen electrode 31, transparent spacers 42, sensing electrodes 33, a transparent second touchscreen electrode 32, and a transparent second touchscreen substrate 44. The electrodes are typically indium tin oxide (ITO) sputter coated onto the substrate. The purpose of the spacers 42 is to keep the first and the second touchscreen electrodes 31, 32 separated by an air gap 43. The reason for this will be explained with regard to FIG. 2.

Although the embodiment shown in FIG. 1 is a resistive touchscreen, a capacitive touchscreen could also be used. Capacitive touchscreens are similar to resistive touchscreens, except they consist of only a single electrode and substrate, with sensing electrodes located in the four corners of the assembly. The electrode for a capacitive touchscreen is typically located such to expose it to the viewer.

FIG. 2 shows a side view of a traditional, resistive touchscreen-display device as known in the art, with the touchscreen activated. An input device 2, such as a stylus or finger, applies pressure to the first touchscreen substrate 41, causing the touchscreen substrate 41 and the first touchscreen electrode 31 to deflect until the first touchscreen electrode 31 comes into contact with the second touchscreen electrode 32. As both touchscreen electrodes 31, 32 are held at a given voltage, contact between them generates a current. The touchscreen sensing electrodes 33 measure the current generated and calculate the location of the touch, by extrapolating distance from the sensing electrode 33 from a calculation using the sheet resistance of the first and second touchscreen electrode 31, 32 materials. In this embodiment, the display 10 is not flexed, and the touchscreen 30 must be at least partially transparent for the display image to be viewed.

In the case that a capacitive touchscreen is used, sensing is done in a slightly different manner. In the capacitive system, the electrode surface is held at a specific voltage. When a conductive input device with some intrinsic capacitance contacts the electrode, the capacitor charges, causing current to flow. The sensors arrayed around the electrode measure this current flow, and calculate the position of the contact. The advantage to this system over the resistive method is that only one electrode and one substrate are required. The disadvantages are that the input device must be conductive and there are a very limited number of protective materials that can be placed over the electrode without interfering with touch input. Additionally, the electronics required to measure the touch are typically more complex than those used in a resistive system.

FIG. 3 is a cross-sectional view of a flexible, single substrate, polymer dispersed liquid crystal (PDLC) display 10 as known in the art. In this embodiment, the display 10 formed from a transparent plastic display substrate 11, with an active display layer 21. The active display layer 21 consists of a transparent, first display electrode 25, a display imaging layer 22, and a second display electrode 26. The display imaging layer 22 consists of a layer of polymer dispersed LC droplets, in which the LC material 24 is held in a series of droplets, surrounded by a polymeric shell 23. The shells 23 form a matrix that maintains the shape of the droplets, the alignment of the LC material 24, and the overall thickness of the active display layer 21. The active display layer 21 can further consist of a colored layer (not shown) to define the color of the display.

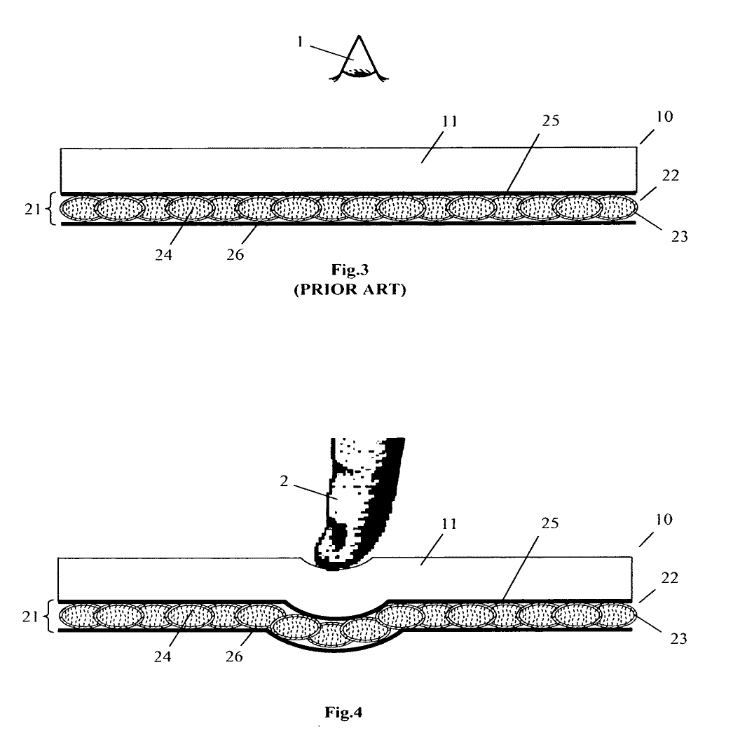

FIG. 4 is a cross-sectional view of a polymer-dispersed display in a flexed position. As can be seen in the figure, because the LC material 24 is held within the polymeric shells 23, the alignment of the LC and the layer thickness is maintained even during an abrupt flexure imparted by an input device 2 onto the display substrate 11 and the active display layer 21. This is an important characteristic for creating a simplified touchscreen-display device.

FIGS. 5, 6, 7, and 8 show side views of different embodiments of a combination PDLC media with a resistive or capacitive touchscreen. FIG. 5 shows an assembly of a PDLC display 10 in front of a traditional resistive touchscreen 30 relative to a viewer 1. In the unactuated position of this embodiment, a first touchscreen electrode 31 is held with a specific gap 43 from a second touchscreen electrode 32. The gap 43 is maintained by the intrinsic stiffness of a first and second touchscreen substrates 41, 44 held apart by spacers 42. The viewer 1 can enter information into the system via the touchscreen 30 by applying point pressure to the system using an input device 2, such as a stylus or finger. The point pressure causes the display 10, the first touchscreen substrate 41, and the first touchscreen electrode 31 to be deflected until the first touchscreen electrode 31 comes into contact with the second touchscreen electrode 32. This contact completes a circuit and allows the touch to be sensed, as was described in FIG. 2. As the display 10 is electrically independent of the touchscreen 30 in this embodiment, it can be written before, during, or after the touch input registers. The display can be written as a result of the touch. The display could also not be written.

The unique pressure and flexure insensitivity of the PDLC display 10 allows a touch-sensing display assembly to be created in this manner, without any additional layers or optical losses due to the touchscreen 30. In addition, as both the display 10 and touchscreen 30 can be made at least partially flexible, the total assembly can be similarly flexible.

FIG. 6 shows a side view of a similar system to that of FIG. 5, with a small modification. Because the touchscreen 30 is located behind the display 10, it can be made non-transparent without any losses to the optical properties of the display. Allowing non-transparent touchscreen materials to be used could yield substantial cost reductions, as the transparent touchscreen electrodes 31, 32 are frequently expensive. In addition, this may also allow for the first and second touchscreen substrates 41, 44 to be replaced by combination electrode-substrates, which was infeasible on the traditional configuration, as increased electrode thickness typically equated to reduced transparency.

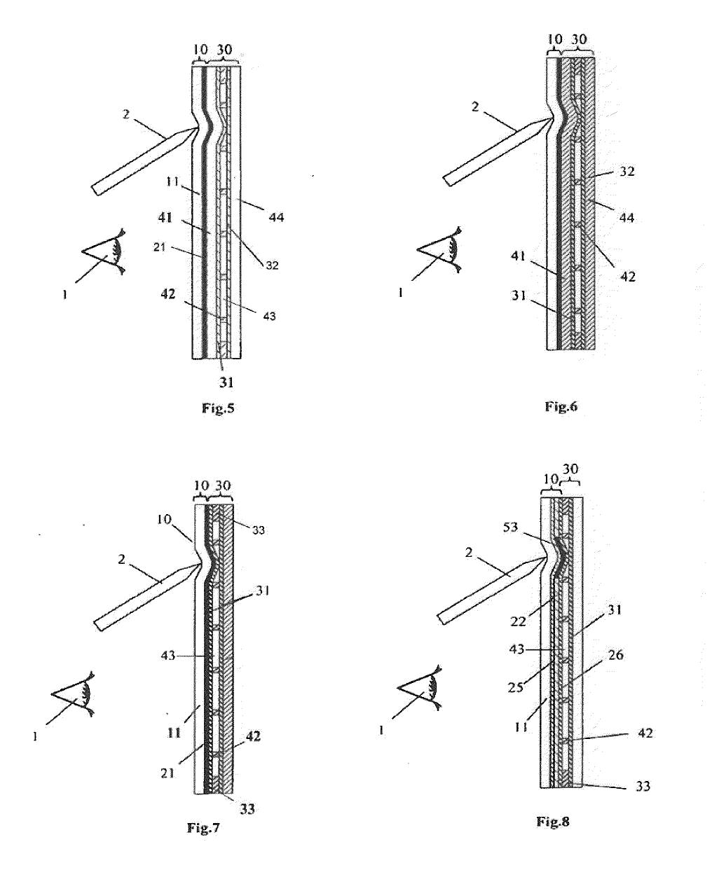

FIG. 7 shows a side view of an additional refinement, in which the first touchscreen substrate 41 of FIG. 6 is removed, and the first touchscreen electrode 31 is applied directly to the back of the display layer 10. If the active display layer 21 ends in a conductive layer, then an insulating layer (not shown) may be required between the display 10 and the first touchscreen electrode 31 to avoid interference between sensing and display writing. Replacing the first touchscreen substrate 41 with the display 10 could enable significant cost and manufacturing advantages, as not only does it reduce the number of parts, but also the first touchscreen electrode 31, the spacers 42, and the sensing electrodes 33, could all be printed directly onto the display 10 in the same method as is used to apply the second display electrode 26 onto the display 10 illustrated in FIG. 3, during manufacturing.

FIG. 8 shows a side view of a fully integrated system, in which the writing of the display media and the touch sensing occur simultaneously. In this embodiment, the first display electrode 25 is formed as a single, common sheet. The second display electrode 26 is patterned into individual pixels, which can be of any shape or size. Non-conductive spacers 42 are applied to the display 10, and the assembly can be laminated to a continuous conductive sheet, forming the first touchscreen electrode 31. Depending on the sensing method used, either the first display electrode 25 or the first touchscreen electrode 31 can be connected with the appropriate electrical components to form a capacitive touchscreen and the drive plane for the display material. This is possible, as both capacitive touchscreens and liquid crystal display layers are voltage driven systems. In the preferred embodiment, the first touchscreen electrode 31 is connected to electrical components that can generate sufficient voltages to electrically write the display imaging layer 22 to either focal conic or planar states. The electrical components can be further capable of sensing the position of a contact by a conductive material with a finite capacitance by measuring the current at the multiple corners of the display. The first display electrode 25 can be set to ground. In this embodiment, pixels can be addressed by applying either the focal conic or planar voltages to the first touchscreen electrode 31, then applying point pressure to deform the assembly such that one or more of the pixels that form the second display electrode 26 come into electrical contact with the first touchscreen electrode 31. The pixel or pixels that are put in contact will become a written pixel 53 that is put into an optical state as is defined by the drive signal on the first touchscreen electrode 31. Pixels can be written to the opposite state by changing the voltage on the first touchscreen electrode 31 and deflecting the system again to put the two electrodes into contact. If the first touchscreen electrode 31 is also wired to be a capacitive touchscreen, then the position of the contact can be sensed and recorded, as was described in FIG. 2.

One advantage of this system is that it does not require a conductive probe to be used, as is the case with typical capacitive touchscreens. This is the case because the display electrode is what actually makes contact with the capacitive touchscreen, so the electrical properties of the input device are irrelevant. Additionally, the touchscreen electrode is buried behind the display, protecting it from damage and allowing transparent or opaque materials to be used. The true elegance of this system is that a fully addressable, pixilated display can be made with a very small number of drive input channels. For the display portion, only two drive input channels are required, one on the first display electrode, and one on the first touchscreen electrode. That is a significant advantage over active, or even passive matrix systems, which require hundreds, thousands, or even millions of drive channels to be used. Such as system could have broad use in any application that required manual input of electronic information with instantaneous display to the viewer, such as signature displays, electronic notation boards, PDAs, or the like.

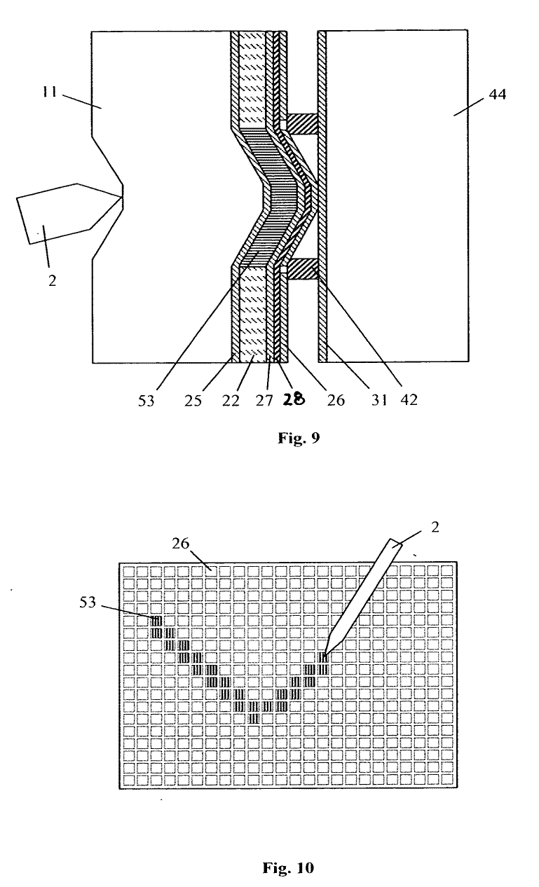

FIGS. 9, 10, 11, and 12 describe an alternate device, based on the same pixel-writing system as in FIG. 8, but with the ability to automatically write the display in addition to the manual write. This could be a simple, bulk reset of the optical state of all the pixels, or it could be a passive matrix write of selected pixels. This ability could be desirable in the situation where it is undesirable to require physical contact for every change of the display.

FIG. 9 is a side view of one potential system that could allow manual and automatic writing. In this embodiment, a third display electrode 27 and an insulating layer 28 are added between the display imaging layer 22 and the second display electrode 26. In this embodiment the display imaging layer 22 can be written by applying an electric field either between the first and second display electrodes 25, 26, or between the first and third display electrodes 25, 27. The second display electrode 26 can be activated as described in FIG. 8, and the third display electrode 27 can be activated by permanent or temporary electrical contact with additional drive electronics.

In this embodiment the second display electrode 26 can still be patterned into pixels, and the third display electrode 27 can be either patterned or unpatterned. If the first and third display electrodes are unpatterned, then the system will only be capable of bulk writing the entire display to either planar or focal conic states. If the first and third display electrodes are patterned to form a passive matrix and connected to sufficient electronics, then individual areas of the display can be made to selectively switch.

FIG. 10 is a front view of a display of the type described in FIG. 8 or FIG. 9. The input device 2 applies point pressure to the material causing the unwritten pixels patterned into the second display electrode 26 to become written pixels 53. Changes to the voltage applied to the system could reverse the writing either automatically or during manual entry depending on the configuration of the assembly.

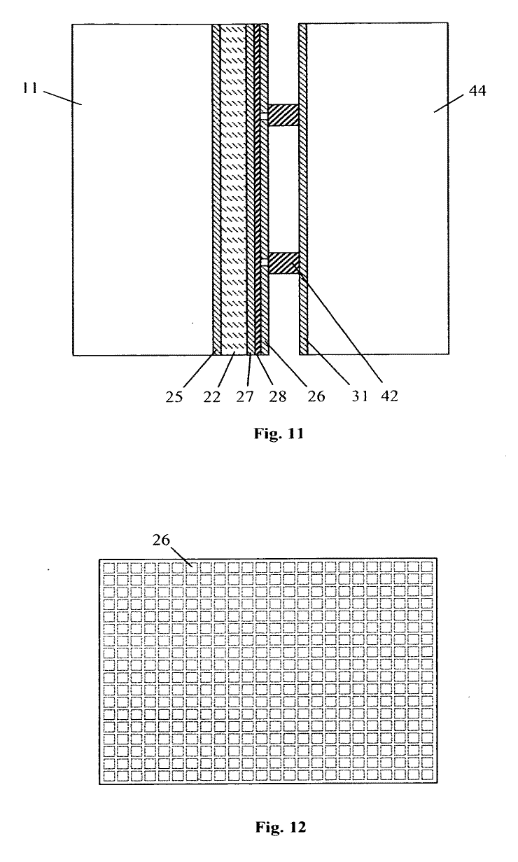

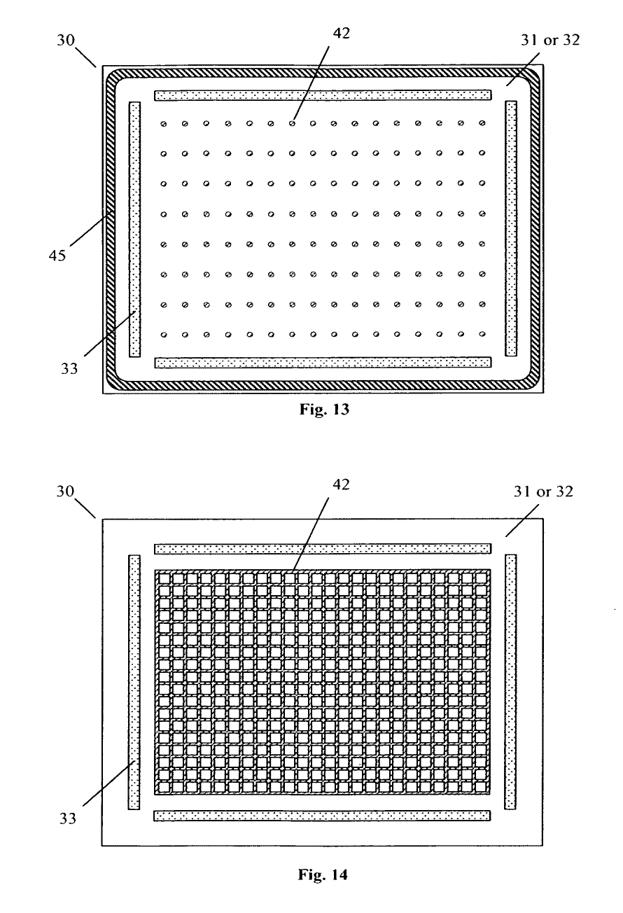

FIG. 11 is a side view of the configuration from FIG. 9, with the written pixels automatically switched back to the opposite state. FIG. 12 is a front view of this same embodiment.

It should obvious to one skilled in the art that all of the embodiments described in FIGS. 5 through 12 can be made independently or combined. A display could be made with one or more portion as an active touchscreen, or one or more portion as an active display. Displays could also be made with one or more portion capable of manual writing or one or more portion capable of automatically writing. Pixel or matrix patterning can be in any shape or size, including but not limited to, polygonal, segmented, iconic, or bulk.

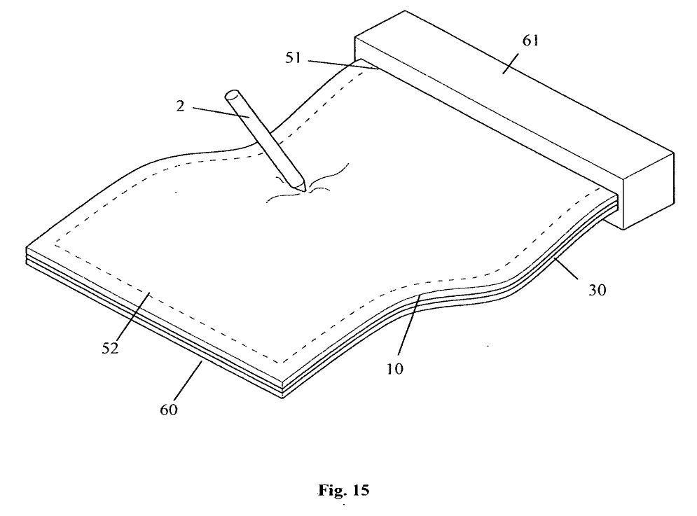

One area that has not been discussed in detail in this specification is the spacer. FIG. 13 is a front view of a typical spacer configuration on the touchscreen assembly 30. The display plane is not shown. In this embodiment the spacer 42 consists of an array of small, dots of a transparent, non-conductive material applied onto the first or second touchscreen electrode 31, 32, depending on what type of touchscreen is used. The dots are typically as small and infrequent as possible, to minimize visual disruption of the display, in the traditional display-in-back assembly configuration. The sensing electrodes 33 are typically arranged outside of the spacer 42 and viewing area perimeter, and can be inside or outside of the touchscreen seal 45. The touchscreen seal 45 is typically a more robust and thicker adhesive than the spacer 42, and usually is the primary mechanism by which the system is held together, and may significantly contribute to maintaining a gap between touchscreen electrodes. The dots typically cannot fulfill the mechanical bond portion of this function, as their small total area provides minimal bond strength. The touchscreen seal 45 may also be required in certain environments to control the environment within the touchscreen gap. For example, in a high humidity environment, the seal may reduce humidity ingression and avoid fogging of the gap, which would reduce transmittance and could short the touchscreen.

There are several limitations to the dot-style spacer design. Aside from requiring the additional seal layer, the large gaps between dots can lead to touchscreen failure if the touchscreen is permanently or temporarily deformed, such as would happen if the material was folded, bent, or kinked. Additionally, if a high voltage touchscreen is used, such as was described in the manual write system, then the electrostatic charge can cause the electrodes to become stuck to one another.

FIG. 14 is a front view of an alternative spacer design, which utilizes a grid instead of dots. This is possible in systems where the touchscreen is positioned behind the display, as it will not interfere optically with display viewing. In this embodiment, the spacer 42 is patterned to form a grid, which can be complementary to the patterns formed in the display electrodes. For example, it could be the perimeter of a single pixel, multiple pixels, or unrelated to the pixels. The advantage of the grid pattern is that it reduces the free span of the substrates, maintaining the touchscreen gap better than the dots when the assembly is bent or folded. Additionally, the increased surface area, and complete perimeter may make the use of a touchscreen seal unnecessary. The grid also can be sized to overcome electrostatic forces in the high voltage system.

FIG. 15 is an isometric view of a potential final assembly utilizing many of the features described in this specification. The display 10 and the touchscreen 30 can be connected along an interconnect edge 51 to drive electronics 61, forming a partially flexible touch-sensing display assembly 60 with an active display area 52. The pixel writing and sensing systems can be used to allow manual or automatic entry of data, and the grid spacer can maintain touchscreen gap regardless of assembly flexing. The final assembly can be flexible in space, application, or configuration, optimizing usefulness and cost for a multitude of systems.

The invention has been described in detail with particular reference to certain preferred embodiments thereof, but it will be understood that variations and modifications can be effected within the spirit and scope of the invention.

### PARTS LIST

1 viewer
2 input device
10 display plane
11 polymer display substrate
12 glass display substrate
21 active display layer
22 display imaging layer
23 polymer shell
24 liquid crystal
25 first display electrode
26 second display electrode
27 third display electrode
28 insulating layer
30 touchscreen
31 first touchscreen electrode
32 second touchscreen electrode
33 touchscreen sensing electrodes
41 first touchscreen substrate
42 spacers
43 air gap
44 second touchscreen substrate
45 touchscreen seal
51 interconnect edge
52 display area
53 written pixel
60 touch-sensing display assembly
61 touch sensor and display drive electronics

1-20. (canceled)

21. An electrically updatable device comprising:
a substrate;
a first conductive layer disposed on the substrate;
a pressure-insensitive imaging layer disposed on the first conductive layer, the imaging layer including a polymer-dispersed imaging material;
a second conductive layer disposed on the imaging layer;
a third conductive layer separated from the second conductive layer by a gap, the second conductive layer configured to contact the third conductive layer upon pressure applied to the substrate;
a plurality of sensing electrodes disposed between the second conductive layer and the third conductive layer, the sensing electrode configured to determine the location of the pressure applied to the substrate; and
one or more spacers disposed in the gap between the second conductive layer and the third conductive layer.

22. The device of claim 21, further comprising a second substrate disposed on the third conductive layer.

23. The device of claim 21, further comprising a fourth conductive layer disposed between the imaging layer and an insulating layer, wherein the insulating layer is disposed between the imaging layer and the second conductive layer.

24. The device of claim 21, wherein the second conductive layer is patterned into individual pixels.

25. The device of claim 21, wherein the display has an electronically-updateable portion, and the updatable portion overlaps at least a portion of the sensing electrodes.

26. The device of claim 21, wherein the sensing electrodes is at least partially opaque.

27. The device of claim 21, wherein at least a portion of the display is segmented, pixilated, or a combination thereof.

28. The device of claim 21, wherein the sensing electrodes are mechanical, electrical, electromechanical, acoustic, optical, or a combination thereof.

29. The device of claim 21, wherein the sensing electrodes are resistive, capacitive, ultrasonic, infrared, or a combination thereof.

30. The device of claim 21, wherein at least a portion of the device is flexible.

31. The device of claim 21, wherein the imaging material is liquid crystal.

32. An electrically updatable device comprising:
a substrate;
a first conductive layer disposed on the substrate;
an imaging layer disposed on the first conductive layer;
a second conductive layer disposed on the imaging layer;
a third conductive layer separated from the second conductive layer by a gap, the second conductive layer configured to contact the third conductive layer upon pressure applied to the substrate;
a sensor disposed between the second conductive layer and the third conductive layer, the sensor configured to determine the location of the pressure applied to the substrate; and
one or more spacers disposed in the gap between the second conductive layer and the third conductive layer.

33. The device of claim 32, further comprising a second substrate disposed on the third conductive layer.

34. The device of claim 32, wherein the second conductive layer is patterned into individual pixels.

35. The device of claim 34, wherein the first conductive layer is set to ground and the third conductive layer is applied voltage.

36. The device of claim 32, further comprising a fourth conductive layer disposed between the imaging layer and an insulating layer, wherein the insulating layer is disposed between the imaging layer and the second conductive layer.

37. The device of claim 36, wherein the first conductive layer is patterned into a first lines, the fourth conductive layer is patterned into a second lines non-parallel to the first lines.

38. The device of claim 32, wherein at least of a portion of the device is flexible.

39. The device of claim 32, wherein at least one of the first and the second conductive layers is opaque.

40. An electrically updatable device comprising:
a substrate;
a first conductive layer disposed on the substrate;
an imaging layer disposed on the first conductive layer;
a second conductive layer disposed on the imaging layer, the second conductive layer being patterned into individual pixels;
a third conductive layer separated from the second conductive layer by a gap, the second conductive layer configured to contact the third conductive layer upon pressure applied to the substrate;
a sensor disposed between the second conductive layer and the third conductive layer, the sensor configured to determine the location of the pressure applied to the substrate; and
one or more spacers disposed in the gap between the second conductive layer and the third conductive layer.
